(19) United States
(12) Patent Application Publication
(10) Pub. No.: US 2024/0402358 A1
(43) Pub. Date: Dec. 5, 2024

(54) DETERMINATION OF A LOCATION CHARACTERISTIC

(71) Applicant: STMicroelectronics International N.V., Geneva (CH)

(72) Inventors: Jerome DURAND, Le Mans (FR); Nicola Matteo PALELLA, rivolta d'adda (IT); Leonardo COLOMBO, Lecco (IT)

(73) Assignee: STMicroelectronics International N.V., Geneva (CH)

(21) Appl. No.: 18/671,027

(22) Filed: May 22, 2024

(30) Foreign Application Priority Data
May 31, 2023 (FR) 2305447

(51) Int. Cl. G01S 19/39; G01S 19/29; G01S 19/42; G01S 19/52; H04W 4/029

(52) U.S. Cl. CPC G01S 19/393; G01S 19/29; G01S 19/42; G01S 19/52; H04W 4/029

(57) ABSTRACT

A device includes global positioning circuitry, sensing circuitry, and processing circuitry. The global positioning circuitry, in operation, receives location-related data. The sensing circuitry, in operation, senses data related to the device. The processing circuitry, in operation, determines a motion state of the electronic system based on data sensed by the sensing circuitry, and selects a plurality of control parameters from one or more configuration matrixes based on the determined motion state. The plurality of control parameters includes a power-mode control parameter and a location-determination control parameter. The processing circuitry configures a power-mode of the device based on the power-mode control parameter, and determines a location characteristic of the device based on the received location-related data and the location-determination control parameter.

### BACKGROUND

### Technical Field

The present disclosure generally concerns electronic systems and devices, and more particularly the determination of one or a plurality of location characteristics of such electronic systems or devices.

### Description of the Related Art

There currently exist different ways of locating an object in space. One consists in using a satellite positioning system data to determine a location of an object, such as an electronic system or device. The electronic device or system may be a motor vehicle.

### BRIEF SUMMARY

In an embodiment, a method comprises: receiving, by processing circuitry of an electronic system, location-related data; sensing, using sensing circuitry of the electronic system, data related to the electronic system; determining, using the processing circuitry, a motion state of the electronic system based on the sensed data; selecting, using the processing circuitry, a plurality of control parameters from one or more configuration matrixes based on the determined motion state, the plurality of control parameters including a power-mode control parameter and a location-determination control parameter; configuring a power-mode of the electronic system based on the power-mode control parameter; and determining a location characteristic of the electronic system based on the received location-related data and the location-determination control parameter.

In an embodiment, a device includes global positioning circuitry, sensing circuitry, and processing circuitry. The global positioning circuitry, in operation, receives location-related data. The sensing circuitry, in operation, senses data related to the device. The processing circuitry, in operation, determines a motion state of the electronic system based on data sensed by the sensing circuitry, and selects a plurality of control parameters from one or more configuration matrixes based on the determined motion state. The plurality of control parameters includes a power-mode control parameter and a location-determination control parameter. The processing circuitry configures a power-mode of the device based on the power-mode control parameter, and determines a location characteristic of the device based on the received location-related data and the location-determination control parameter.

In an embodiment, a system comprises: a memory; and processing circuitry coupled to the memory. The processing circuitry, in operation: receives location-related data; senses data related to the system; determines a motion state of the system based on the sensed data; selects a plurality of control parameters from one or more configuration matrixes based on the determined motion state, the plurality of control parameters including a power-mode control parameter and a location-determination control parameter; configures a power-mode of the system based on the power-mode control parameter; and determines a location characteristic of the system based on the received location-related data and the location-determination control parameter.

In an embodiment, a non-transitory computer-readable medium's contents cause a processing system to perform a method, the method comprising: receiving location-related data; sensing data related to the system; determining a motion state of the system based on the sensed data; selecting a plurality of control parameters from one or more configuration matrixes based on the determined motion state, the plurality of control parameters including a power-mode control parameter and a location-determination control parameter; configuring a power-mode of the system based on the power-mode control parameter; and determining a location characteristic of the system based on the received location-related data and the location-determination control parameter.

An embodiment provides a method of determining a first location characteristic of an electronic system comprising at least one sensor, and a satellite positioning device composed of at least one module for calculating said first characteristic, E(Vel)), comprising the following successive steps:
using said satellite positioning device to obtain first data;
using said at least one sensor to determine a state of said system;
selecting at least one first configuration parameter from a first configuration matrix by using the state of said system;
configuring said calculation module by using said at least one first parameter; and
calculating said first characteristic, E(Vel)) by using said calculation module.

Another embodiment provides an electronic system comprising a satellite positioning device, at least one sensor, and at least one module for calculating a first location characteristic, E(Vel)) of said system and adapted to implementing a method of determining said first location characteristic, E(Vel)) comprising the following successive steps:
using said satellite positioning device to obtain first data;
using said at least one sensor to determine a state of said system;
selecting at least one first configuration parameter from a first configuration matrix by using the state of said system;
configuring said calculation module by using said at least one first parameter; and
calculating said first characteristic, E(Vel)) by using said calculation module.

According to an embodiment, said at least one sensor is selected from the group comprising: a velocity sensor, an acceleration sensor, a gyroscope, an angular velocity sensor, an altitude sensor, a pressure sensor, a proximity sensor, and/or a Time of Flight sensor.

According to an embodiment, said first data comprise one or a plurality of measurements of pseudo-ranges, and one or a plurality of measurements of Doppler frequencies.

According to an embodiment, said calculation module is a Kalman filter.

According to an embodiment, said first parameter is selected from the group comprising: a parameter representing a matrix of noise measurements linked to pseudo-ranges, a parameter representing a matrix of noise measurements linked to Doppler frequencies, a parameter representing a covariance matrix linked to the extrapolation of the estimate of a position, and a parameter representing a covariance matrix linked to the extrapolation of the estimate of a velocity.

According to an embodiment, the first location characteristic is an estimate of the position) of said system.

According to an embodiment, the first location characteristic is an estimate of the velocity) of said system.

According to an embodiment, the method is, further, a method of determination of a second location characteristic, E(Pos)) of said system.

According to an embodiment, the second location characteristic is an estimate of the position) of said system.

According to an embodiment, the second location characteristic is an estimate of the velocity) of said system.

According to an embodiment, the system further comprises a sampler adapted to receiving said first data and the method further comprises the following successive steps:
selecting at least one second configuration parameter from a second configuration matrix by using the state of said system;
configuring said sampler by using said at least one second parameter; and
sampling said first data by using said sampler.

According to an embodiment, said second parameter is selected from the group comprising: a sampling rate.

According to an embodiment, the system further comprises a processor, and the method further comprises the following successive steps:
selecting at least one third configuration parameter from a third configuration matrix by using the state of said system; and
configuring said processor by using said at least one third parameter.

According to an embodiment, said third parameter is selected from the group comprising: an operating frequency, a power supply voltage, a low-power operating mode.

According to an embodiment, the system is a motor vehicle.

### BRIEF DESCRIPTION OF THE SEVERAL VIEWS OF THE DRAWINGS

The foregoing features and advantages, as well as others, will be described in detail in the rest of the disclosure of specific embodiments given by way of illustration and not limitation with reference to the accompanying drawings, in which:

FIG. 1 very schematically shows in the form of blocks an embodiment of an electronic system;

FIG. 2 shows, in the form of blocks, a more detailed embodiment of a portion of the electronic system of FIG. 1;

FIG. 3 shows a block diagram illustrating an example of an operating method of a portion of the embodiment of FIG. 2;

FIG. 4 shows four series of graphs illustrating the example of the operating method described in relation with FIG. 3;

FIG. 5 shows an example of embodiment of a matrix of parameters of the embodiment of FIG. 2;

FIG. 6 shows a block diagram illustrating the example of operating method of another portion of the embodiment of FIG. 2;

FIG. 7 shows an example of embodiment of another matrix of parameters of the embodiment of FIG. 2; and

FIG. 8 shows an example of embodiment of another matrix of parameters of the embodiment of FIG. 2.

### DETAILED DESCRIPTION

Like features have been designated by like references in the various figures, unless the context indicates otherwise. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, when reference is made to absolute positional qualifiers, such as the terms “front,” “back,” “top,” “bottom,” “left,” “right,” etc., or to relative positional qualifiers, such as the terms “above,” “below,” “upper,” “lower,” etc., or to qualifiers of orientation, such as “horizontal,” “vertical,” etc., reference is made, unless specified otherwise, to the orientation of the figures.

Unless specified otherwise, the expressions “around,” “approximately,” “substantially” and “in the order of” signify within 10%, and optionally, within 5%.

The embodiments described hereafter concern the locating of an electronic system, and, more particularly, the determination of one or a plurality of positioning characteristics of an electronic system.

There is called, hereafter, positioning characteristic, or location characteristic, of an electronic system, a physical quantity associated with an electronic system enabling to qualify its positioning, or its location, in space. Examples of positioning characteristics are the following:
the relative, or absolute, position of the electronic system, expressed via two or three coordinates in a defined reference frame;
the relative, or absolute, velocity of the electronic system;
the relative, or absolute, acceleration of the electronic system;
the heading direction of the electronic system, that can be represented by a vector; and
the orientation in space of the electronic system, that can be expressed via one or more angles in a defined reference frame.

According to an embodiment, other examples of positioning characteristics are the following:
the absolute position of the electronic system, expressed via three coordinates in the Earth-Centered Earth Fixed (ECEF) reference frame;
the absolute velocity of the electronic system in the Earth-Centered Earth Fixed (ECEF) reference frame;
the absolute acceleration of the electronic system in the Earth-Centered Earth Fixed (ECEF) reference frame.

In particular, the embodiments described hereafter concern the determination of a state of the system to provide an estimate of one or a plurality of positioning characteristics of said system. For this purpose, the system uses configuration parameters determined based on its physical state to configure a calculation module, such as a Kalman filter, receiving data obtained by a satellite positioning device (GNSS, Global Navigation Satellite System). The embodiments described hereafter thus provide a better accuracy of the estimate of said one or a plurality of positioning characteristics.

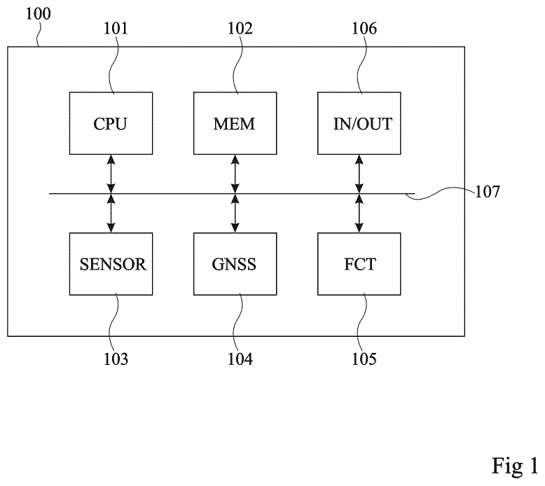

FIG. 1 is a block diagram very schematically showing an architecture of an example of an electronic system 100 adapted to executing an implementation mode of the method of determining one or a plurality of location characteristics described hereafter.

Electronic system 100 comprises a processor 101 (CPU) adapted to implementing different processing of data stored in memories and/or supplied by other circuits of system 100.

Electronic system 100 further comprises one or a plurality of memories 102 (MEM), for example, memories 102 of different types, among which, for example, a non-volatile memory, a volatile memory, and/or a ROM. Each memory 102 is adapted to storing different types of data.

Electronic system 100 may further comprise interface circuits 106 (IN/OUT) adapted to sending and/or to receiving data originating from the outside of system 100. Interface circuit 106 may further be adapted to implementing a data display, for example, a display screen.

Electronic system 100 further comprises one or a plurality of sensors 103 (SENSOR) adapted to measuring one or a plurality of physical quantities linked to system 100. According to an example, one of sensors 103 may be adapted to measuring, or suitable for measuring, an estimate a data that is functional for the calculation of a positioning characteristic. Sensor(s) 103 are selected from the group comprising: a distance sensor, also known as an odometer, a velocity sensor, also known as speed sensor, an acceleration sensor, also known as accelerometer, an angular rate sensor, also known as a gyroscope or an angular velocity sensor, an altitude sensor, also known as a barometer, a pressure sensor, a proximity sensor, a heading sensor, also known as a magnetometer, and a Time of Flight (ToF) sensor.

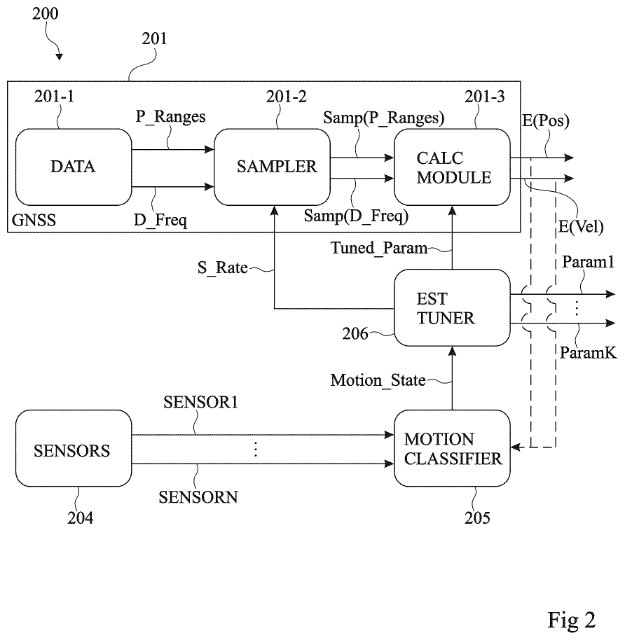

According to an embodiment, the measurements performed by sensor(s) 103 are used to determine a physical state of system 100. An example of a module adapted to determining the state of system 100 according to sensors 103 is described in relation with FIG. 2 to 4.

Electronic system 100 further comprises a satellite positioning device 104 (GNSS), or satellite positioning system (GNSS, Global Navigation Satellite Systems) or geo-positioning or localization device. Device 104 is able to receive, decode and provide measurements from signals received from one or more constellations of satellite positioning systems. Device 104 is used by system 100 to provide an estimate of one or a plurality of positioning characteristics of system 100. According to an example embodiment, device 104 is adapted to being implemented to provide an estimate of the position and/or of the velocity of system 100. For this purpose, device 104 is adapted to providing data which, once processed, enable to provide these estimates of positioning characteristics. According to an example embodiment, device 104 is, among others, adapted to delivering:
data representing pseudo-range measurements (Pseudoranges and/or Phase ranges) which are indirect distance measurements based on a delay exhibited by a signal on reception thereof as compared with its transmission; and
data representing Doppler frequency measurements (Doppler Frequencies) which are measurements of frequency differences between a nominal frequency of a transmitted signal carrier and the frequency of a received signal.

Electronic system 100 further comprises different elements 105 (FCT) adapted to performing different functions. As an example, elements 105 may comprise motor elements, mechanical elements, etc.

Electronic system 100 further comprises one or a plurality of data buses 107 adapted to transferring data between its different components.

According to an example embodiment, system 100 is selected from the non-exhaustive group comprising:
all forms of moving equipment, motor driven or not;
all forms of motor-driven terrestrial vehicles, such as motor vehicles;
all forms of motor-driven aquatic vehicles, such as, for example, a boat; and
all forms of motor-driven aircrafts, such as for example, a plane or a drone;
all forms of sports equipment; and
all forms of connected objects.

FIG. 2 very schematically shows in the form of blocks a more detailed embodiment of a portion of a system 200 of the type of the system 100 described in relation with FIG. 1.

As previously described, system 200 comprises a satellite positioning device 201 (GNSS) of the type of the device 104 described in relation with FIG. 1. Device 201 includes:
a sub-device 201-1 (DATA) known as a satellite tracking system;
a sampler 201-2 (SAMPLER); and
a calculation module 201-3 (CALC MODULE).

Sub-device 201-1 is adapted to outputting one or a plurality of data P_Ranges representing pseudo-range measurements, called hereafter pseudo-ranges P_Ranges. Device 201-1 is further adapted to outputting one or a plurality of data D_Freq representing Doppler frequency measurements, called Doppler frequencies D_Freq hereafter.

Sampler 201-2 (SAMPLER) is adapted to receiving data from sub-device 201-1. More particularly, according to an embodiment, sampler 201-2 is adapted to receiving pseudo-ranges P_Ranges and Doppler frequencies D_Freq. Sampler 201-2 is adapted to outputting sampled data. More particularly, sampler 201-2 outputs:
sampled pseudo-ranges Samp(P_Ranges) corresponding to the sampled pseudo-ranges P_Ranges; and
sampled Doppler frequencies Samp(D_Freq) corresponding to the sampled Doppler frequencies D_Freq.

Calculation module 201-3 is a module for determining one or a plurality of positioning characteristics of system 200. Calculation module 201-3 is adapted to receiving, as an input, sampled data from sampler 201-2 and to outputting estimates of one or a plurality of positioning characteristics of system 200. More particularly, calculation module 201-3 is adapted to receiving the sampled data Samp(P_Ranges) and Samp(D_Freq). According to a specific embodiment, calculation module 201-3 is adapted to outputting an estimate of the position E(Pos) and of the velocity E(Vel) of system 200. According to a variant, calculation module 201-3 may enable to provide other estimates of positioning characteristics of system 200.

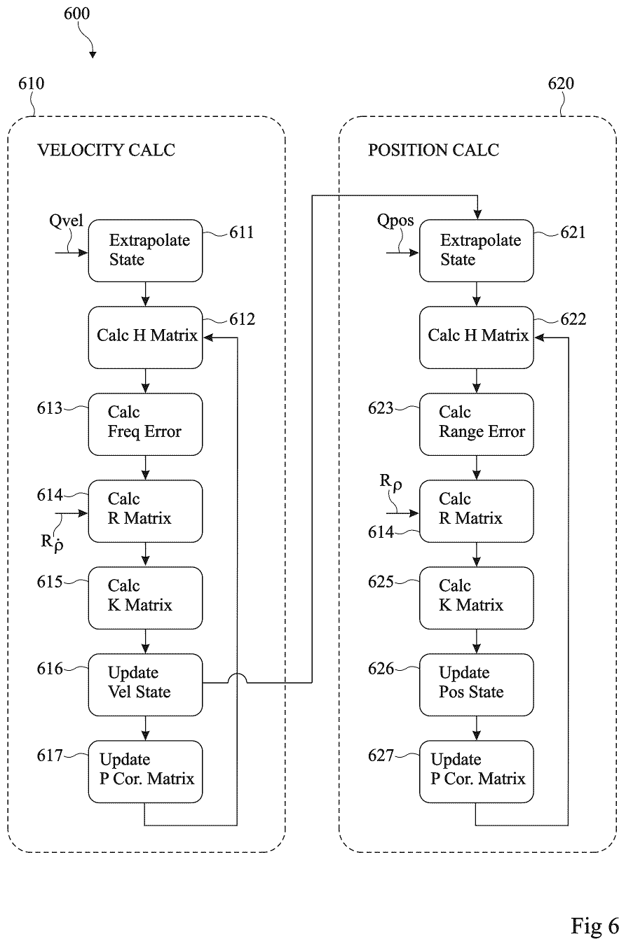

According to an embodiment, calculation module 201-3 is adapted to implementing one or a plurality of calculation algorithms enabling to provide estimates of positioning characteristics of system 200. According to an example embodiment, calculation module 201-3 is adapted to implementing a Kalman filter. An example of implementation of calculation module 201-3 is described in relation with FIG. 6.

As previously described, system 200 further comprises one or a plurality of sensors 204 (SENSORS) of the type of the sensors 103 described in relation with FIG. 1. In the example shown in FIG. 2, sensor(s) 204 are adapted to delivering N data elements, N being an integer greater than or equal to one, representing N measurements performed by sensor(s) 204. According to an example, system 200 comprises N sensors 204, each sensor being adapted to delivering a data element SENSORi, i varying from 1 to N. According to a variant, system 200 comprises M sensors 204, M being an integer smaller than N, among which at least one of sensors 204 is adapted to delivering a plurality of data SENSORi.

According to an embodiment, sensor(s) 204 comprise, at least:
one sensor of the acceleration along a first axis Ox;
one sensor of the acceleration along a second axis Oy perpendicular to the first axis Ox; and
a sensor of the angular position, also called gyroscope, along a third axis Oz perpendicular to the first and second axes Ox and Oy.

According to another embodiment, sensor(s) 204 may also comprise:
one sensor of the acceleration along each axis Ox, Oy and Oz; and
one sensor of the angular position along each axis Ox, Oy and Oz.

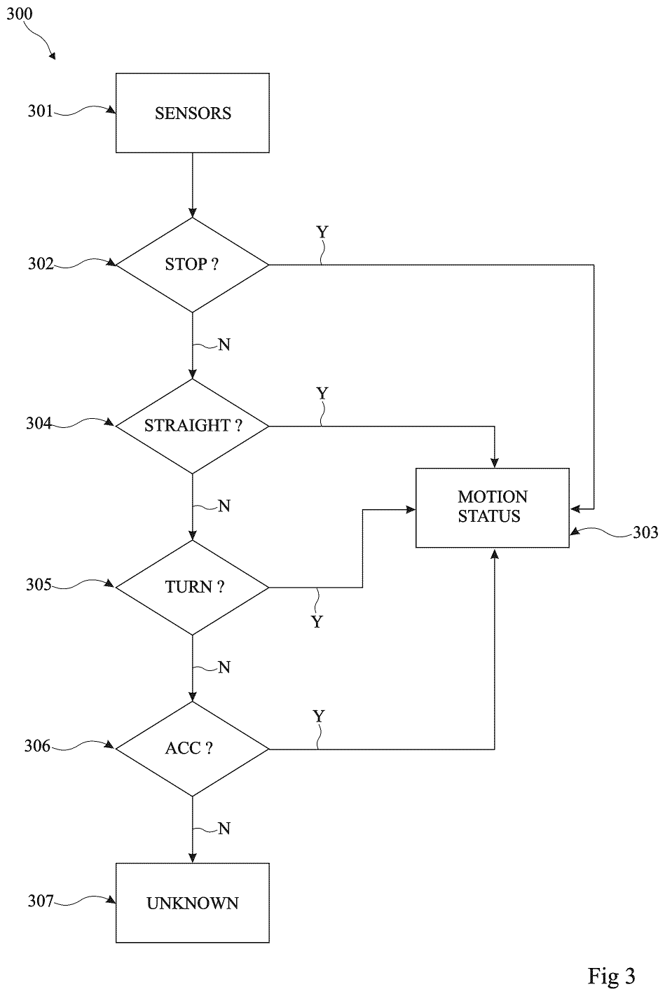

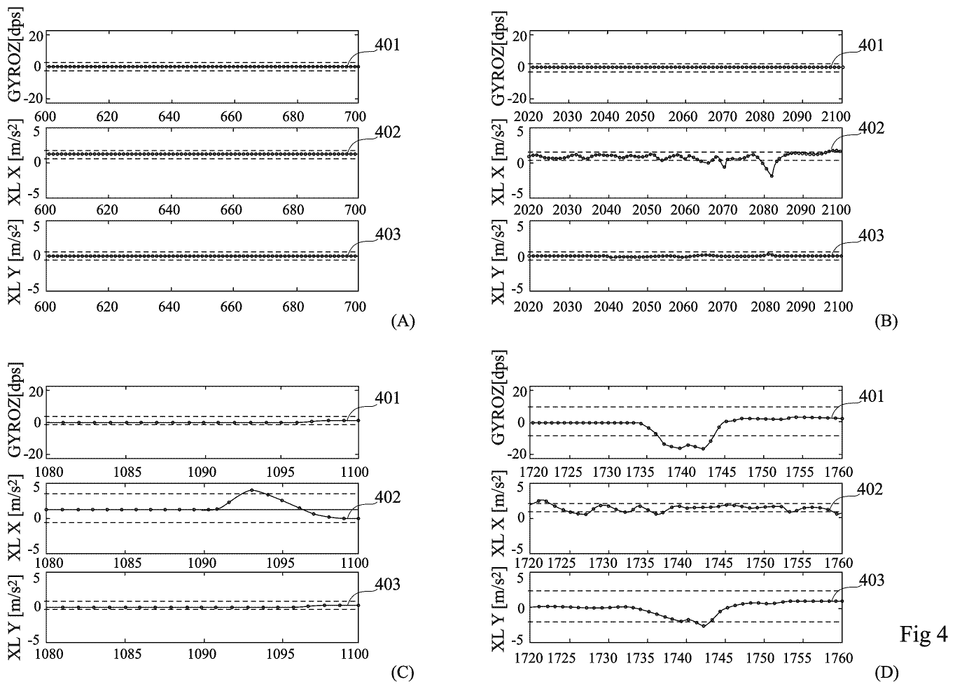

The system further comprises a module for determining 205 (MOTION CLASSIFIER) the state of system 200. Module 205 is adapted to receiving, as an input, the data SENSOR1, . . . , SENSORN obtained by sensor(s) 204. Module 205 is adapted to outputting data Motion_State indicating the state in which system 200 finds itself. An example of implementation of the module is described in further detail in relation with FIGS. 3 and 4.

There is here called state of system 200 the motion state of system 200. In other words, the system state characterizes its motion in a defined reference frame. According to a specific embodiment, the state of system 200 may be selected from the group comprising:
a motionless state, also called a stop state;
a straight line forward constant velocity motion state;
a straight line reverse constant velocity motion state;
a straight line acceleration motion state;
a curved line constant velocity motion state; and
a curved line acceleration motion state; and
a “none of all above” state, that is a state that is not identified as one of the other defined states.

According to an alternative embodiment, module 205 is adapted to taking into account, further, one or a plurality of already-calculated estimates of positioning characteristics of system 200 to determine the state of system 200. According to a specific embodiment, module 205 may receive already-calculated previous estimates of the position E(Pos) and of the velocity E(Vel) of system 200.

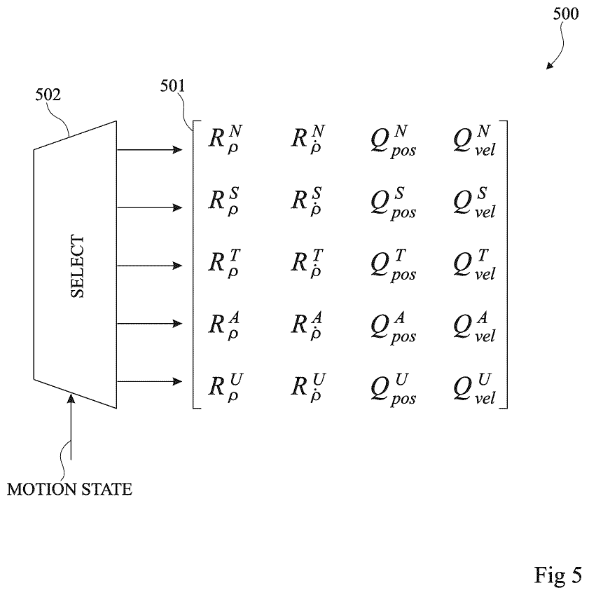

The system further comprises a parameter generation module 206 (EST TUNER). This module 206 is adapted to receiving as an input data Motion_State and to outputting different parameters enabling to configure elements or circuits of system 200 according to the state of system 200. For this purpose, and according to an embodiment, the parameter generation module comprises one or a plurality of parameter correlation matrices. Examples of such matrices are described in relation with FIGS. 5, 7, and 8.

According to an embodiment, module 206 is more particularly adapted to delivering parameters Tuned_Param enabling to configure the data processing performed by calculation module 201-3. According to an example embodiment, parameters Tuned_Param are Kalman filter configuration parameters taking into account the state of system 200. For this purpose, module 206 uses a configuration matrix comprising all the values that parameters Tuned_Param can take 200. An example of such a configuration matrix is described in detail in relation with FIG. 5.

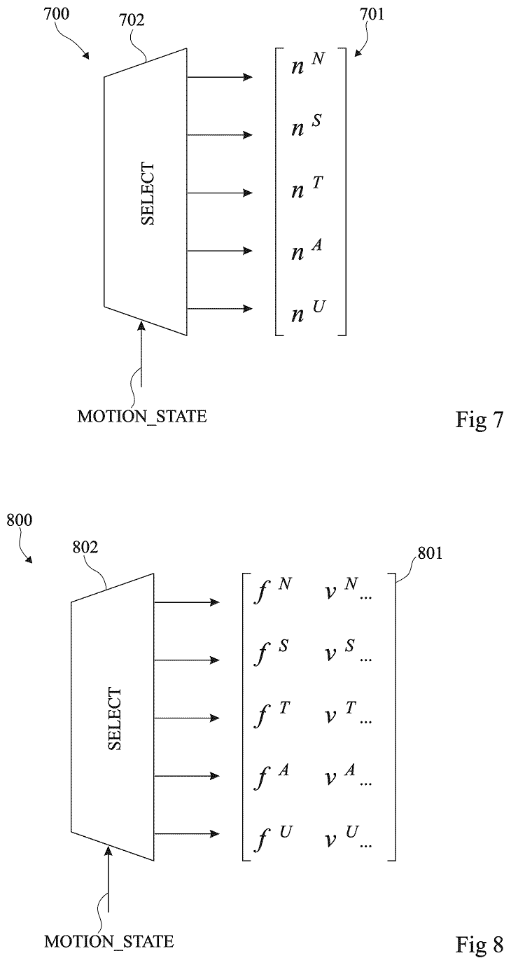

According to an embodiment, optionally, parameter generation module 206 is adapted to delivering one or a plurality of parameters for configuring sampler 201-2. According to an example, module 206 is adapted to delivering a parameter representing the sampling rate S_Rate of sampler 201-2 which takes into account the state of system 200. For this purpose, module 206 uses a configuration matrix comprising all the values that parameters S_Rate can take according to the different states of system 200. An example of such a configuration matrix is described in detail in relation with FIG. 7.

According to an embodiment, optionally, parameter generation module 206 is adapted to delivering one or a plurality of parameters for configuring other elements of system 200, such as, for example, K parameters Param1, . . . , ParamK, K being an integer greater than or equal to one. For this purpose, module 206 uses a configuration matrix comprising all the values that parameters Param1, . . . , ParamK can take according to the different states of system 200. An example of such a configuration matrix is described in detail in relation with FIG. 8.

According to an example, Param1, . . . , ParamK are configuration parameters of a processor of system 200 or of a processor of system 100 described in relation with FIG. 1. More particularly, parameters Param1, . . . , ParamK comprise a parameter representing an operating frequency of the processor, a power supply voltage of the processor, and/or an operating mode influencing the power consumption of system 200.

The operation of system 200 is thus the following, satellite positioning system 201 and sensors 204 supply, in real time, data to system 200. Module 205 uses data SENSOR1 to SENSORN to determine the state in which system 200 finds itself. Module 206 uses this state to configure certain elements of system 200 and thus take into account the state of system 200 to calculate estimates of positioning characteristics of system 200. More particularly, and according to an embodiment calculation module 201-3 is configured to take into account this state.

FIG. 3 is a block diagram illustrating an example of an operating method 300 of a module for determining a state, or motion status, of the system, of the type of the module 205 and of the system 200 described in relation with FIG. 2.

In the example of FIG. 3, the determination module is adapted to selecting the state of the system comprising it from among a group comprising:
a state STOP where the system is motionless;
a state STRAIGHT where the system moves forward in a straight line;
a state TURN where the system moves forward in a curved line;
a state ACC where the system is accelerating; and
a state UNKNOWN where the system state is undetermined.

Other states of the system can be envisaged. In this case, the adaptation of the operating method described hereafter is within the abilities of those skilled in the art.

At an initial step 301 (SENSORS), the determination module receives data from sensors embarked in the system, of the type of the sensors 204 described in relation with FIG. 2. As a reminder, according to an example embodiment, these sensors may be acceleration sensors and an angular rate sensor.

According to a variant, at step 301, the determination module may further receive already previously calculated estimates of positioning characteristics of the system.

At a step 302 (STOP?), successive to step 301, the determination module analyzes the data and determines whether the system is at state STOP. According to an example, the module compares the sensor data with a series of data typical of state STOP. If the module determines that the system is at state STOP (output Y of step 302), then the next step is a step 303 (MOTION STATUS), otherwise (output N of step 302) the next step is a step 304 (STRAIGHT?).

At step 303, successive to step 302, the determination module indicates that the system is at state STOP. According to an example, the determination module supplies data, of the type of data Motion_State described in relation with FIG. 2, indicating state STOP.

At step 304, successive to step 302, the state of the system is not state STOP, the determination module analyzes again the data and determines whether the system is at state STRAIGHT. According to an example, the module compares the data of the sensors with a series of data typical of state STRAIGHT. If the module determines that the system is at state STRAIGHT (output Y of step 304) then the next step is step 303 (MOTION STATUS), otherwise (output N of step 304) the next step is a step 305 (TURN?).

At step 303, successive to step 304, the determination module indicates that the system is at state STRAIGHT.

At step 305, successive to step 304, the system state is neither state STOP nor state STRAIGHT, the determination module analyzes, again, the data and determines whether the system is at state TURN. According to an example, the module compares the data of the sensors with a series of data typical of state TURN. If the module determines that the system is at state TURN (output Y of step 305), then the next step is step 303 (MOTION STATUS), otherwise (output N of step 305) the next step is a step 306 (ACC?).

At step 303, successive to step 305, the determination module indicates that the system is at state TURN.

At step 306, successive to step 305, the system state is neither state STOP nor state STRAIGHT, nor state TURN, the determination module analyzes, again, the data and determines whether the system is at state ACC. According to an example, the module compares the data of the sensors with a series of data typical of state ACC. If the module determines that the system is at state ACC (output Y of step 306), then the next step is step 303 (MOTION STATUS), otherwise (output N of step 306) the next step is a step 306 (UNKONWN).

At step 303, successive to step 306, the determination module indicates that the system is at state ACC.

At step 307, successive to step 306, the system state is neither state STOP, not state STRAIGHT, nor state ACC. The system is thus at undetermined state UNKNOWN. The determination module indicates that the system is a state UNKNOWN.

According to an alternative embodiment, the order in which the different states of the system are tested may be modified.

FIG. 4 comprises four series (A), (B), (C), and (D) of graphs illustrating examples of data typical of sensors of a state of the system of the type of the data SENSOR1 to SENSORN described in relation with FIG. 2.

More particularly, each series (A), (B), (C), and (D) comprises three curves 401, 402, and 403. Curve 401 shows data obtained by a sensor of the angular position, also called angular rate sensor, along axis Oz. Curve 402 shows data obtained by an acceleration sensor along axis Ox. Curve 403 shows data obtained by an acceleration sensor along axis Oy. Axes Ox, Oy, and Oz have been defined in relation with FIG. 2.

According to a first example, series (A) illustrates the data typical of a motionless state STOP of the system, described in relation with FIG. 3. Indeed, none of curves 401 to 403 exhibits a variation.

According to a second example, series (B) illustrates the data typical of a state STRAIGHT of the system, described in relation with FIG. 3. Indeed, only curve 402 exhibits substantially constant variations, whereby the system only displaces along a rectilinear direction.

According to a third example, series (C) illustrates the data typical of a state ACC of the system, described in relation with FIG. 3. Indeed, curve 402 exhibits a significant variation, whereby the system exhibits an acceleration phase.

According to a fourth example, series (D) illustrates the data typical of a state TURN of the system, described in relation with FIG. 3. Indeed, curve 401 exhibits a significant variation, and curves 402 and 403 also exhibit variations, whereby the system is following a curved line.

FIG. 5 shows an implementation mode of an operating method 500 of a module for determining parameters of a system, of the type of the module 206 and of the system 200 described in relation with FIG. 2. FIG. 5 illustrates in particular a matrix of parameters 501 used by the calculation module. According to one example, matrix 501 is obtained by using module 206 for executing method 300 described in relation with FIG. 3.

Operating mode 500 represents the generation, by the parameter generation module 206, of parameters, of the type of the parameters Tuned_Param of FIG. 2, intended to configure a calculation module of the type of the module 201-3 described in relation with FIG. 2.

To generate these parameters, the parameter generation module uses a configuration matrix 501 comprising all the values that the configuration parameters of the calculation module can take for each state of the system. According to an example, each row of matrix 501 comprises the values of the configuration parameters for a single state of the system, and each column of matrix 501 comprises the values of a same parameter for each state of the system. According to a variant, the rows and columns may be inverted.

The parameter generation module further uses a selection tool 502 adapted to receiving data Motion_State representing the state of the system, and to selecting the parameters from the configuration matrix. More particularly, according to an example, selection tool 502 is adapted to selecting a row of matrix 501, or possibly a column, according to the value of data Motion_State. The row, or column, of parameters is then supplied to the calculation module.

In the example shown in FIG. 5, matrix 501 comprises values of four Kalman filter configuration parameters corresponding to five different states of the system. Thus, matrix 501 comprises four columns and five rows.

The four parameters are the following:
a parameter Rₚ representing a covariance matrix of measurements noise linked to the pseudo-ranges supplied by the satellite positioning device of the system;
a parameter Rₚ representing a covariance matrix of measurements noise linked to the Doppler frequencies supplied by the satellite positioning device of the system;
a parameter Qₚₒₛ representing a covariance matrix of process noise linked to the extrapolation of the estimate of the user of the system position; and
a parameter Qᵥₑₗ representing a covariance matrix of process noise linked to the extrapolation of the estimate of the user of the system velocity.

The five states are the following:
a state N representing a basic state of the system;
a state S representing a motionless state of the system;
a state T representing a state of the system where the system has a curved trajectory;
a state A representing a state of acceleration of the system; and
a state U representing an undetermined state of the system.

In FIG. 5, each cell of matrix 501 represents the value of one of the parameters previously mentioned for a previously-mentioned state of the system. More particularly, each cell of matrix 501 is provided by the following mathematical formula:

A^{x} Math 1

where:
A is the parameter, that is, one of the previously-described parameters Rₚ, Rₚ, Qₚₒₛ or Qᵥₑₗ; and
X is the state of the system, that is, one of the previously-described states N, S, T, A, or U.

FIG. 6 shows an example of implementation of an operating mode 600 of a calculation module of the system, of the type of the calculation module 201-3 and of the system 200 described in relation with FIG. 2.

In the specific example of FIG. 6, the calculation module implements a Kalman filter by using the parameters Rₚ, Rₚ, Qₚₒₛ or Qᵥₑₗ described in relation with FIG. 5 to determine the position and the velocity of the system.

Operating mode 600 comprises two series of steps 610 (VELOCITY CALC) and 620 (POSITION CALC). The series of steps 610 enables to determine the velocity of the system, and the series of steps 620 enables to determine the system position. According to an embodiment, the series of steps 610 is implemented before the series of steps 620.

At an initial step 611 (Extrapolate State) of the series of steps 610, the calculation module extrapolates the value of the system velocity. The amount of velocity variation allowed may be modulated by using parameter Qᵥₑₗ.

At a step 612 (Calc H Matrix), successive to step 611, a system observation matrix, generally called matrix H of a Kalman filter, is calculated. Matrix H is function of problem geometry, that is mainly of current estimated system and satellite position.

At a step 613 (Calc Freq Error), successive to step 612, an error frequency is determined. This error frequency is a difference between the frequency measurement for current satellite position provided by GNSS device and a predicted frequency yielded from the combination of system user velocity and satellite velocity.

At a step 614 (Calc R Matrix), successive to step 613, parameter Rₚ is provided to the calculation module to calculate a measurement noise matrix. Such matrix determines the level of acceptance of the frequency measurement and the way it influences velocity estimation.

At a step 615 (Calc K Matrix), successive to step 614, a gain matrix of the Kalman filter, generally called K matrix, is calculated by using the measurement noise matrix determined at the previous step.

At a step 616 (Update Vel State), successive to step 615, an estimate of the system velocity is calculated, and updated. This value is further used to determine the system position in the series of steps 620. The velocity update is dependent of the frequency error calculated at step 613, of the measurement noise matrix calculated at step 614, and of the gain matrix calculated at step 615.

At a step 617 (Update P Coy Matrix), successive to step 616, the calculation module uses the updated value of the system velocity to update the error covariance matrix P of the Kalman filter.

Concerning the estimate of the system position, at an initial step 621 (Extrapolate State) of the series of steps 620, the calculation module extrapolates the value of the system position. The amount of position variation allowed is modulated by parameter Qₚₒₛ.

At a step 622 (Calc H Matrix), successive to step 621, the observation matrix H of the system is calculated. Matrix H is function of system geometry, that is mainly of current estimated system and satellite position

At a step 623 (Calc Range Error), successive to step 622, an error of pseudorange is determined. This error is a difference between the pseudorange measurement for current satellite provided by GNSS device and a predicted pseudorange yielded from the combination of system position and satellite position.

At a step 624 (Calc R Matrix), successive to step 623, parameter Rₚ is provided to the calculation module to calculate a measurement noise matrix. Such matrix determines the level of acceptance of the pseudorange measurement and the way it influences position estimation.

At a step 625 (Calc K Matrix), successive to step 624, the gain matrix K of the Kalman filter is calculated by using the measurement noise matrix determined at the previous step.

At a step 626 (Update Pos State), successive to step 625, an estimate of the system position is calculated, and updated. The velocity update is function of the pseudorange error calculated at step 623, of the measurement noise matrix calculated at step 624, and of the gain matrix calculated at step 625.

At a step 627 (Update P Cov Matrix), successive to step 626, the calculation module uses the updated value of the system position to update the error covariance matrix P of the Kalman filter.

The series of steps 610 and 620 are examples of implementation of Kalman filters. Other implementations are possible and are within the abilities of those skilled in the art.

FIG. 7 shows an example of another operating method 700 of a module for determining parameters of a system, of the type of the module 206 and of the system 200 described in relation with FIG. 2. FIG. 7 illustrates in particular a matrix of parameters 701 used by the sampler. According to one example, matrix 701 is obtained by using module 206 for executing method 300 described in relation with FIG. 3.

Operating mode 700 shows the generation, by the parameter generation module, of parameters, of the type of the parameters S_Rate of FIG. 2, intended to configure a sampler of the type of the sampler 201-2 described in relation with FIG. 2.

To generate these parameters, the parameter generation module uses a configuration matrix 701, of the type of the matrix 501 described in relation with FIG. 5, comprising all the values that the configuration parameters of the sampler can take for each state of the system. According to an example, each row of matrix 701 comprises the values of the configuration parameters for a single state of the system, and each column of matrix 701 comprises the values of a same parameter for each state of the system. According to a variant, the rows and columns may be inverted.

The parameter generation module further uses a selection tool 702 adapted to receiving data Motion_State representing the state of the system, and to selecting the parameters from configuration matrix 701. More particularly, according to an example, selection tool 702 is adapted to selecting a row of matrix 701, or possibly a column, according to the value of data Motion_State. The row, or column, of parameters is then supplied to the sampler.

In the example shown in FIG. 7, matrix 701 comprises values of a single sampler configuration parameter corresponding to five different states of the system. Thus, matrix 701 comprises one column and five rows.

The parameter of matrix 701 is the sampling rate n of the sampler.

The five states are the same as the states described in relation with FIG. 5, that is, the following states:
state N representing the basic state of the system;
state S representing the motionless state of the system;
state T representing the state of the system where the system has a curved trajectory;
state A representing the acceleration state of the system; and
state U representing the undetermined state of the system.

In FIG. 7, each cell of matrix 701 represents the value of one of the previously-mentioned parameters for a previously-mentioned state of the system, and the same writing convention as that used in FIG. 5 is used.

FIG. 8 shows an example of another operating method 800 of a module for determining parameters of a system, of the type of the module 206 and of the system 200 described in relation with FIG. 2. FIG. 8 illustrates in particular a matrix of parameters 801 used by the device. According to one example, matrix 801 is obtained by using module 206 for executing method 300 described in relation with FIG. 3.

Operating mode 800 represents the generation, by the parameter generation module, of parameters, of the type of the parameters Param1, . . . , ParamK of FIG. 2, intended to configure other elements of a system described in relation with FIG. 2 or a system described in relation with FIG. 1.

To generate these parameters, the parameter generation module uses a configuration matrix 801, of the type of the matrices 501 and 701 described in relation with FIGS. 5 and 7, comprising all the values that the configuration parameters of the system elements can take. According to an example, each row of matrix 801 comprises the values of the configuration parameters for a single state of the system, and each column of matrix 801 comprises the values of a same parameter for each state of the system. According to a variant, the rows and columns may be inverted.

The parameter generation module further uses a selection tool 802 adapted to receiving data Motion_State representing the state of the system, and to selecting the parameters from the configuration matrix. More particularly, according to an example, selection tool 802 is adapted to selecting a row of matrix 801, or possibly a column, according to the value of data Motion_State. The row, or column, of parameters is then supplied to the calculation module.

In the example shown in FIG. 8, matrix 801 comprises values of at least two configuration parameters of a processor, such as processor 101 of system 100 of FIG. 1, of the system corresponding to five different states of the system. Thus, matrix 801 comprises two columns and five rows.

The two parameters are the following:
a parameter f representing a clock frequency of the system processor; and
a parameter v representing a value of a power supply voltage of the system processor.

Other parameters may be envisaged herein and are within the abilities of those skilled in the art.

The five states are the same as the states of FIGS. 5 and 7, that is, the following states:
state N representing a basic state of the system;
state S representing a motionless state of the system;
state T representing a state of the system where the system has a curved trajectory;
state A representing an acceleration state of the system; and
state U representing an undetermined state of the system.

In FIG. 8, each cell of matrix 801 represents the value of one of the previously-mentioned parameters for a previously-mentioned state of the system, and the same writing convention as that described in relation with FIGS. 5 and 7 is used.

Various embodiments and variants have been described. Those skilled in the art will understand that certain features of these various embodiments and variants may be combined, and other variants will occur to those skilled in the art.

Finally, the practical implementation of the described embodiments and variations is within the abilities of those skilled in the art based on the functional indications given hereabove.

Method of determining a first location characteristic of an electronic system (100; 200) may be summarized as including at least one sensor (103; 204), and a satellite positioning device (104; 201) composed of at least one module (201-3) for calculating said first characteristic (E(Pos), E(Vel)), including the following successive steps: using said satellite positioning device (104; 201) to obtain first data (P_Ranges, D_Freq); using said at least one sensor (103; 204) to determine a state of said system (100; 200); selecting at least one first configuration parameter (Tuned_Param) from a first configuration matrix (501) by using the state of said system (100; 200); configuring said calculation module (201-3) by using said at least one first parameter (Tuned_Param); and calculating said first characteristic (E(Pos), E(Vel)) by using said calculation module (201-3).

Electronic system may be summarized as including a satellite positioning device (104; 201-1), at least one sensor (103; 204), and at least one module (201-3) for calculating a first location characteristic (E(Pos), E(Vel)) of said system (100; 200) and adapted to implementing a method of determining said first location characteristic (E(Pos), E(Vel)) including the following successive steps: using said satellite positioning device (104; 201) to obtain first data (P_Ranges, D_Freq); using said at least one sensor (103; 204) to determine a state of said system (100; 200); selecting at least one first configuration parameter (Tuned_Param) from a first configuration matrix (501) by using the state of said system (100; 200); configuring said calculation module by using said at least one first parameter (Tuned_Param); and calculating said first characteristic (E(Pos), E(Vel)) by using said calculation module (201-3).

Said at least one sensor (103; 204) may be selected from the group including: a velocity sensor, an acceleration sensor, a gyroscope, an angular velocity sensor, an altitude sensor, a pressure sensor, a proximity sensor, and/or a Time of Flight (ToF) sensor.

Said first data may include one or a plurality of measurements of pseudo-ranges (P_Ranges), and one or a plurality of measurements of Doppler frequencies (D_Freq).

Said calculation module (201-3) may be a Kalman filter.

Said first parameter may be selected from the group including: a parameter (R_{ρ}) representing a matrix of noise measurements linked to pseudo-ranges, a parameter (R_{\dot{ρ}}) representing a matrix of noise measurements linked to Doppler frequencies, a parameter (Qₚₒₛ) representing a covariance matrix linked to the extrapolation of the estimate of a position, and a parameter (Q,ᵥₑₗ) representing a covariance matrix linked to the extrapolation of the estimate of a velocity.

The first location characteristic may be an estimate of the position (E(Pos)) of said system (100; 200).

The first location characteristic may be an estimate of the velocity (E(Vel)) of said system (100; 200).

The method may be, further, a method of determination of a second location characteristic (E(Vel), E(Pos)) of said system (100; 200).

The second location characteristic may be an estimate of the position (E(Pos)) of said system (100; 200).

The second location characteristic may be an estimate of the velocity (E(Vel)) of said system (100; 200).

The system (100; 200) may further include a sampler (201-2) adapted to receiving said first data (P_Ranges, D_Freq) and the method may further include the following successive steps: selecting at least one second configuration parameter (S_Rate, n) from a second configuration matrix (701) by using the state of said system (100; 200); configuring said sampler (201-2) by using said at least one second parameter (S_Rate, n); and sampling said first data (P_Ranges, D_Freq) by using said sampler (201-2).

Said second parameter (S_Rate, n) may be selected from the group including: a sampling rate.

The system (100; 200) may further include a processor (101), and the method may further include the following successive steps: selecting at least one third configuration parameter (Param1, . . . , ParamK; f, v) from a third configuration matrix (801) by using the state of said system (100; 200); and configuring said processor (101) by using said at least one third parameter (Param1, ParamK; f, v).

Said third parameter (Param1, . . . , ParamK; f, v) may be selected from the group including: an operating frequency, a power supply voltage, a low-power operating mode.

The system (100; 200) may be a motor vehicle.

In an embodiment, a method comprises: receiving, by processing circuitry of an electronic system, location-related data; sensing, using sensing circuitry of the electronic system, data related to the electronic system; determining, using the processing circuitry, a motion state of the electronic system based on the sensed data; selecting, using the processing circuitry, a plurality of control parameters from one or more configuration matrixes based on the determined motion state, the plurality of control parameters including a power-mode control parameter and a location-determination control parameter; configuring a power-mode of the electronic system based on the power-mode control parameter; and determining a location characteristic of the electronic system based on the received location-related data and the location-determination control parameter.

In an embodiment, the sensing data comprises: sensing a velocity associated with the electronic system; sensing an acceleration associated with the electronic system; sensing rotational data associated with the electronic system; sensing an angular velocity associated with the electronic system; sensing an altitude associated with the electronic system; sensing a pressure associated with the electronic system; sensing proximity data associated with the electronic system; sensing distance data associated with the electronic system; sensing temperature data associated with the electronic system; or combinations thereof.

In an embodiment, the receiving location-related data comprises: receiving measurements of pseudo-ranges; receiving measurements of Doppler frequencies; or combinations thereof.

In an embodiment, determining a location characteristic of the electronic system based on the received location-related data and the location-determination control parameter comprises configuring a Kalman filter based on the location-determination parameter and applying the Kalman filter to the received location-related data.

In an embodiment, the plurality of control parameters comprises multiple location-determination control parameters.

In an embodiment, the multiple location-determination control parameters include: a parameter representing a matrix of noise measurements linked to pseudo-ranges; a parameter representing a matrix of noise measurements linked to Doppler frequencies; a parameter representing a covariance matrix linked to extrapolation of an estimate of a position; a parameter representing a covariance matrix linked to extrapolation of an estimate of a velocity; or combinations thereof.

In an embodiment, determining a location characteristic of the electronic system comprises determining one or more location characteristics including: estimating a position of the electronic system; estimating of a velocity of the electronic system; or combinations thereof.

In an embodiment, the processing circuitry includes sampling circuitry, the plurality of control parameters includes a sampling-rate control parameter and the method comprises: setting a sampling rate of the sampling circuitry based on the sampling-rate control parameter; sampling the received location-related data using the sampling circuitry; and determining the location characteristic of the electronic system based on the sampled location-related data and the location-determination control parameter.

In an embodiment, the power-mode control parameter comprises one or more power-mode control parameters, and the method comprises: setting an operating frequency based on the one or more power-mode control parameters; setting a power-supply voltage based on the one or more power-mode control parameters; setting a power-mode of the electronic system based on the one or more power-mode control parameters; or combinations thereof.

In an embodiment, a device includes global positioning circuitry, sensing circuitry, and processing circuitry. The global positioning circuitry, in operation, receives location-related data. The sensing circuitry, in operation, senses data related to the device. The processing circuitry, in operation, determines a motion state of the electronic system based on data sensed by the sensing circuitry, and selects a plurality of control parameters from one or more configuration matrixes based on the determined motion state. The plurality of control parameters includes a power-mode control parameter and a location-determination control parameter. The processing circuitry configures a power-mode of the device based on the power-mode control parameter, and determines a location characteristic of the device based on the received location-related data and the location-determination control parameter.

In an embodiment, the sensing circuitry comprises: a velocity sensor; an accelerometer; a gyroscope; an angular velocity sensor; an altitude sensor; a pressure sensor; a proximity sensor; a time-of-flight sensor; a temperature sensor; or combinations thereof.

In an embodiment, the global positioning circuitry, in operation: receives measurements of pseudo-ranges; receives measurements of Doppler frequencies; or combinations thereof.

In an embodiment, the processing circuitry comprises a Kalman filter, and in operation, the processing circuitry configures the Kalman filter based on the location-determination parameter and filters the received location-related data using the configured Kalman filter.

In an embodiment, the plurality of control parameters comprises multiple location-determination control parameters.

In an embodiment, the multiple location-determination control parameters include: a parameter representing a matrix of noise measurements linked to pseudo-ranges; a parameter representing a matrix of noise measurements linked to Doppler frequencies; a parameter representing a covariance matrix linked to extrapolation of an estimate of a position; a parameter representing a covariance matrix linked to extrapolation of an estimate of a velocity; or combinations thereof.

In an embodiment, the processing circuitry, in operation, determines one or more location characteristics including: an estimated position of the device; an estimated velocity of the device; or combinations thereof.

In an embodiment, the processing circuitry includes sampling circuitry, the plurality of control parameters includes a sampling-rate control parameter and the processing circuitry, in operation: sets a sampling rate of the sampling circuitry based on the sampling-rate control parameter; samples the received location-related data using the sampling circuitry; and determines the location characteristic of the electronic system based on the sampled location-related data and the location-determination control parameter.

In an embodiment, the power-mode control parameter comprises one or more power-mode control parameters, and the processing circuitry, in operation: sets an operating frequency based on the one or more power-mode control parameters; sets a power-supply voltage based on the one or more power-mode control parameters; sets a power-mode of the device based on the one or more power-mode control parameters; or combinations thereof.

In an embodiment, a system comprises: a memory; and processing circuitry coupled to the memory. The processing circuitry, in operation: receives location-related data; senses data related to the system; determines a motion state of the system based on the sensed data; selects a plurality of control parameters from one or more configuration matrixes based on the determined motion state, the plurality of control parameters including a power-mode control parameter and a location-determination control parameter; configures a power-mode of the system based on the power-mode control parameter; and determines a location characteristic of the system based on the received location-related data and the location-determination control parameter.

In an embodiment, the processing circuitry comprises: global positioning circuitry, which, in operation, receives the location related data; and one or more sensors, which, in operation, senses the data related to the system.

In an embodiment, the system comprises a motor vehicle including the memory and the processing circuitry.

In an embodiment, a non-transitory computer-readable medium's contents cause a processing system to perform a method, the method comprising: receiving location-related data; sensing data related to the system; determining a motion state of the system based on the sensed data; selecting a plurality of control parameters from one or more configuration matrixes based on the determined motion state, the plurality of control parameters including a power-mode control parameter and a location-determination control parameter; configuring a power-mode of the system based on the power-mode control parameter; and determining a location characteristic of the system based on the received location-related data and the location-determination control parameter.

In an embodiment, the determining a location characteristic of the system based on the received location-related data and the location-determination control parameter comprises configuring a Kalman filter based on the location-determination parameter and applying the Kalman filter to the received location-related data.

In an embodiment, the contents comprises instructions executed by the processing system.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving, by processing circuitry of an electronic system, location-related data;
sensing, using sensing circuitry of the electronic system, data related to the electronic system;
determining, using the processing circuitry, a motion state of the electronic system based on the sensed data;
selecting, using the processing circuitry, a plurality of control parameters from one or more configuration matrixes based on the determined motion state, the plurality of control parameters including a system-mode control parameter and a location-determination control parameter;
configuring a system mode of the electronic system based on the system-mode control parameter; and
determining a location characteristic of the electronic system based on the received location-related data and the location-determination control parameter.

2. The method according to claim 1, wherein the sensing data comprises:
sensing a velocity associated with the electronic system;
sensing an acceleration associated with the electronic system;
sensing rotational data associated with the electronic system;
sensing an angular velocity associated with the electronic system;
sensing an altitude associated with the electronic system;
sensing a pressure associated with the electronic system;
sensing proximity data associated with the electronic system;
sensing distance data associated with the electronic system;
sensing temperature data associated with the electronic system; or
combinations thereof.

3. The method according to claim 1, wherein the receiving location-related data comprises:
receiving measurements of pseudo-ranges;
receiving measurements of Doppler frequencies; or
combinations thereof.

4. The method according to claim 1, wherein determining a location characteristic of the electronic system based on the received location-related data and the location-determination control parameter comprises configuring a Kalman filter based on the location-determination parameter and applying the Kalman filter to the received location-related data.

5. The method according to claim 4, wherein the plurality of control parameters comprises multiple location-determination control parameters.

6. The method according to claim 5, wherein the multiple location-determination control parameters include:
a parameter representing a matrix of noise measurements linked to pseudo-ranges;
a parameter representing a matrix of noise measurements linked to Doppler frequencies;
a parameter representing a covariance matrix linked to extrapolation of an estimate of a position;
a parameter representing a covariance matrix linked to extrapolation of an estimate of a velocity; or
combinations thereof.

7. The method according to claim 1, wherein determining a location characteristic of the electronic system comprises determining one or more location characteristics including:
estimating a position of the electronic system;
estimating of a velocity of the electronic system; or
combinations thereof.

8. The method according to claim 1, wherein the processing circuitry includes sampling circuitry, the plurality of control parameters includes a sampling-rate control parameter and the method comprises:
setting a sampling rate of the sampling circuitry based on the sampling-rate control parameter;
sampling the received location-related data using the sampling circuitry; and
determining the location characteristic of the electronic system based on the sampled location-related data and the location-determination control parameter.

9. The method according to claim 1, wherein the system-mode control parameter comprises one or more power-mode control parameters, and the method comprises:
setting an operating frequency based on the one or more power-mode control parameters;
setting a power-supply voltage based on the one or more power-mode control parameters;
setting a power-mode of the electronic system based on the one or more power-mode control parameters; or
combinations thereof.

10. A device, comprising:
global positioning circuitry, which, in operation, receives location-related data;
sensing circuitry, which, in operation, senses data related to the device; and
processing circuitry, which, in operation:
determines a motion state of the electronic system based on data sensed by the sensing circuitry;
selects a plurality of control parameters from one or more configuration matrixes based on the determined motion state, the plurality of control parameters including an operational-mode control parameter and a location-determination control parameter;
configures operational mode of the device based on the operational mode control parameter; and
determines a location characteristic of the device based on the received location-related data and the location-determination control parameter.

11. The device according to claim 10, wherein the sensing circuitry comprises:
a velocity sensor;
an accelerometer;
a gyroscope;
an angular velocity sensor;
an altitude sensor;
a pressure sensor;
a proximity sensor;
a time-of-flight sensor;
a temperature sensor; or
combinations thereof.

12. The device according to claim 10, wherein the global positioning circuitry, in operation:
receives measurements of pseudo-ranges;
receives measurements of Doppler frequencies; or
combinations thereof.

13. The device according to claim 10, wherein the processing circuitry comprises a Kalman filter, and in operation, the processing circuitry configures the Kalman filter based on the location-determination parameter and filters the received location-related data using the configured Kalman filter.

14. The device according to claim 13, wherein the plurality of control parameters comprises multiple location-determination control parameters.

15. The device according to claim 14, wherein the multiple location-determination control parameters include:
a parameter representing a matrix of noise measurements linked to pseudo-ranges;
a parameter representing a matrix of noise measurements linked to Doppler frequencies;
a parameter representing a covariance matrix linked to extrapolation of an estimate of a position;
a parameter representing a covariance matrix linked to extrapolation of an estimate of a velocity; or
combinations thereof.

16. The device according to claim 10, wherein the processing circuitry, in operation, determines one or more location characteristics including:
an estimated position of the device;
an estimated velocity of the device; or
combinations thereof.

17. The device according to claim 10, wherein the processing circuitry includes sampling circuitry, the plurality of control parameters includes a sampling-rate control parameter and the processing circuitry, in operation:
sets a sampling rate of the sampling circuitry based on the sampling-rate control parameter;
samples the received location-related data using the sampling circuitry; and
determines the location characteristic of the electronic system based on the sampled location-related data and the location-determination control parameter.

18. The device according to claim 10, wherein the operational-mode control parameter comprises one or more power-mode control parameters, and the processing circuitry, in operation:
sets an operating frequency based on the one or more power-mode control parameters;
sets a power-supply voltage based on the one or more power-mode control parameters;
sets a power-mode of the device based on the one or more power-mode control parameters; or
combinations thereof.

19. A system, comprising:
a memory; and
processing circuitry coupled to the memory, wherein the processing circuitry, in operation:
receives location-related data;
senses data related to the system;
determines a motion state of the system based on the sensed data;
selects a plurality of control parameters from one or more configuration matrixes based on the determined motion state, the plurality of control parameters including a system-mode control parameter and a location-determination control parameter;
configures a mode of the system based on the system-mode control parameter; and
determines a location characteristic of the system based on the received location-related data and the location-determination control parameter.

20. The system of claim 19, wherein the processing circuitry comprises:
global positioning circuitry, which, in operation, receives the location related data; and
one or more sensors, which, in operation, senses the data related to the system.

21. The system of claim 19, comprising a motor vehicle including the memory and the processing circuitry.

22. A non-transitory computer-readable medium having contents which cause a processing system to perform a method, the method comprising:
receiving location-related data;
sensing data related to the system;
determining a motion state of the system based on the sensed data;
selecting a plurality of control parameters from one or more configuration matrixes based on the determined motion state, the plurality of control parameters including a system-mode control parameter and a location-determination control parameter;
configuring a mode of the system based on the system-mode control parameter; and
determining a location characteristic of the system based on the received location-related data and the location-determination control parameter.

23. The non-transitory computer-readable medium according to claim 22, wherein the determining a location characteristic of the system based on the received location-related data and the location-determination control parameter comprises configuring a Kalman filter based on the location-determination parameter and applying the Kalman filter to the received location-related data.

24. The non-transitory computer-readable medium according to claim 22, wherein the contents comprises instructions executed by the processing system.
